(19) United States
(12) Patent Application Publication
(10) Pub. No.: US 2025/0249852 A1
(43) Pub. Date: Aug. 7, 2025

(54) THERMAL COMPONENT PRIORITIZATION CONTROL LOGIC AND METHODS

(71) Applicant: Nikola Corporation, Phoenix, AZ (US)

(72) Inventors: Brandon Dunn, Gilbert, AZ (US); Christopher Kady, Loveland, CO (US); Doheon Lee, Phoenix, AZ (US); Erik Virgil Lindstrom, Queen Creek, AZ (US); Akshit Markan, Tempe, AZ (US)

(21) Appl. No.: 19/045,335

(22) Filed: Feb. 4, 2025

Related U.S. Application Data
(60) Provisional application No. 63/550,811, filed on Feb. 7, 2024.

(51) Int. Cl. B60R 16/033

(52) U.S. Cl. CPC B60R 16/033

(57) ABSTRACT

Disclosed are methods for managing power distribution to a plurality of thermal components of a vehicle. A method may include, responsive to receiving a power budget, allocating, by a thermal management module (TMM), a first power allocation to each active thermal component of the plurality of thermal components. A method may further include allocating, by the TMM, a second power allocation to each active thermal component of the plurality of thermal components based on a power consumption of each active thermal component of the plurality of thermal components. A method may further include allocating, by the TMM, a third power allocation to each active thermal component of the plurality of thermal components by equally distributing any excess power from the power budget following the first power allocations and the second power allocations.

### CROSS-REFERENCE TO RELATED APPLICATION

This application claims priority to, and the benefit of, U.S. Provisional Patent Application No. 63/550,811 filed on Feb. 7, 2024 entitled “THERMAL COMPONENT PRIORITIZATION CONTROL LOGIC AND METHODS.” The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to electrical control and architecture for electric vehicles.

### BACKGROUND

Battery electric vehicles (BEVs) and fuel cell electric vehicles (FCEVs) utilize various components that may be desirably heated and/or cooled in order to be kept within desired operating ranges. Under extreme or challenging conditions, however, cooling or heating demands may be unable to be completely fulfilled. Conventional systems do not provide the ability to customize which components are powered, heated, or cooled, and in which order or relative priority, or to which degree, for example responsive to thermal management being desired or responsive to other constraints, such as total available power to be distributed. Accordingly, there is a need for customizable high-voltage prioritization of high-voltage components, for example when thermal management is desired.

### SUMMARY

A method for managing power distribution to a plurality of thermal components of a vehicle may comprise, responsive to receiving a power budget, allocating, by a thermal management module (TMM), a first power allocation to each active thermal component of the plurality of thermal components, allocating, by the TMM, a second power allocation to each active thermal component of the plurality of thermal components based on a power consumption of each active thermal component of the plurality of thermal components, and allocating, by the TMM, a third power allocation to each active thermal component of the plurality of thermal components by equally distributing any excess power from the power budget following the first power allocations and the second power allocations.

In various embodiments, allocating, by the TMM, the second power allocation to each active thermal component further comprises allocating, by the TMM, additional power based on a power growth buffer associated with each active thermal component of the plurality of thermal components. The method may further comprise setting, by the TMM, a power setpoint for each active thermal component of the plurality of thermal components, and commanding, by the TMM, a component power or a component speed for each active thermal component of the plurality of thermal components. Allocating, by the TMM, the first power allocation to each active thermal component may further comprise for each active thermal component of the plurality of thermal components based on a predetermined priority, determining, by the TMM, whether a power remaining is greater than or equal to a minimum operating power of the active thermal component, and responsive to determining that the power remaining is less than the minimum operating power of the active thermal component, allocating, by the TMM, the power remaining as the first power allocation to the active thermal component.

The method may further comprise responsive to determining that the power remaining is greater than or equal to the minimum operating power of the active thermal component, allocating, by the TMM, the minimum operating power as the first power allocation to the active thermal component. The method may further comprise responsive to allocating the minimum operating power as the first power allocation to the active thermal component, updating, by the TMM, the power remaining to the power remaining minus the allocated minimum power, and repeating the first power allocation for each active thermal component of the plurality of thermal components. Allocating, by the TMM, the second power allocation to each active thermal component may further comprise determining, by the TMM, whether the active thermal component's first power allocation is less than a first predetermined power value, and responsive to determining that the active thermal component's first power allocation is less than the first predetermined power value, allocating, by the TMM, zero power as a second power allocation to the active thermal component.

The method may further comprise responsive to determining that the active thermal component's first power allocation is greater than or equal to the first predetermined power value, determining, by the TMM, whether power consumption of the active thermal component plus a power growth buffer is less than the active thermal component's first power allocation, and responsive to determining that the power consumption of the active thermal component plus the power growth buffer is less than the active thermal component's first power allocation, allocating, by the TMM, a minimum operating power as the second power allocation to the active thermal component. The method may further comprise responsive to determining that the power consumption of the active thermal component plus the power growth buffer is greater than or equal to the active thermal component's first power allocation, determining, by the TMM, whether the power consumption plus the power growth buffer minus the first power allocation of the active thermal component is greater than or equal to a power remaining after prior second power allocations, and responsive to determining that the power consumption plus the power growth buffer minus the first power allocation of the active thermal component is less than the power remaining after the prior second power allocations, allocating, by the TMM, the power consumption plus the power growth buffer as the second power allocation to the active thermal component. The method may further comprise responsive to determining that the power consumption plus the power growth buffer minus the first power allocation of the active thermal component is greater than or equal to the power remaining after the prior second power allocations, allocating, by the TMM, the power remaining after the second power allocations in addition to the first power allocation of the active thermal component as the second power allocation to the active thermal component.

The method may further comprise determining, by the TMM, whether the active thermal component's second power allocation is greater than or equal to an active thermal component's maximum operating power, responsive to determining that the active thermal component's second power allocation is greater than or equal to the active thermal component's maximum operating power, allocating, by the TMM, the active thermal component's maximum operating power as the active thermal component's second power allocation, and responsive to determining that the active thermal component's second power allocation is less than the active thermal component's maximum operating power or responsive to allocating, by the TMM, the active thermal component's maximum operating power as the active thermal component's second power allocation, updating, by the TMM, the power remaining after the second power allocations to be equal to the power remaining after second power allocations minus a difference of the active thermal component's second power allocation and the active thermal component's first power allocation. Allocating, by the TMM, the third power allocation to each active thermal component may further comprise determining, by the TMM, whether the active thermal component's second power allocation is greater than zero, responsive to the determining that the active thermal component's second power allocation is zero, setting, by the TMM, the active thermal component's maximum power equal to zero, and updating, by the TMM, a total maximum power of all active thermal components to a sum of the total maximum power of all active thermal components considered previously and the active thermal component's maximum power, and responsive to determining that the active thermal component's second power allocation is greater than zero, setting, by the TMM, the active thermal component's maximum power equal to the active thermal component's maximum power, and updating, by the TMM, the total maximum power of all active thermal components to a sum of the total maximum power of all active thermal components considered previously and the active thermal component's maximum power. The method may further comprise calculating, by the TMM, how much power could be allocated until all active thermal components are maxed by adding the total maximum power of all active thermal components to a difference of the power available and a power remaining after all third power allocations.

The method may comprise responsive to determining that the power that could be allocated until all active thermal components are maxed is less than or equal to a second predetermined power value, setting, by the TMM, an excess power ratio to one to prevent division by zero or a negative number, and responsive to determining that the power that could be allocated until all active thermal components are maxed is greater than the second predetermined power value, setting, by the TMM, the excess power ratio to a first value determined by dividing the power remaining after all third power allocations by the power that could be allocated until all active thermal components are maxed. The method may further comprise responsive to setting the excess power ratio to one to prevent division by zero or a negative number or setting the excess power ratio to the first value determined by dividing the power remaining after all third power allocations by the power that could be allocated until all active thermal components are maxed, setting, by the TMM, a total allocated power to zero. The method may further comprise responsive to determining that the active thermal component's second power allocation fails to be greater than zero, setting, by the TMM, the active thermal component's third power allocation to zero. The method may further comprise responsive to determining that the active thermal component's second power allocation is greater than zero, adding, by the TMM, excess power, such that the active thermal component's third power allocation is equal to a sum of the excess power ratio times a difference of the active thermal component's maximum power and the active thermal component's second power allocation and the active thermal component's second power allocation. The method may further comprise responsive to determining that the active thermal component's third power allocation is greater than or equal to the active thermal component's maximum power, setting, by the TMM, the active thermal component's third power allocation equal to the active thermal component's maximum power.

A method for controlling an active thermal component of a vehicle may comprise calculating, by a thermal management module (TMM), an active thermal component power setpoint based on a power budget and a component prioritization, calculating, by the TMM, a first error value based on a difference between the active thermal component power setpoint and an active thermal component instantaneous power consumption, calculating, by the TMM, an active thermal component actuation limit using the first error value, calculating, by the TMM, a second error value based on a difference between a primary setpoint and a primary feedback, calculating, by the TMM, a system output variable using the second error value, and limiting, by the TMM, the system output variable based on the active thermal component actuation limit or the active thermal component power setpoint. The method may further comprise commanding, by the TMM, a component speed or a component power of the active thermal component based on the limited system output variable.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a power control system for use in an FCEV, in accordance with various embodiments.

FIG. 2 illustrates a functional block diagram of a thermal management system for an FCEV, in accordance with various embodiments;

FIG. 3 illustrates a high-level flow diagram of a method to manage power distribution to various thermal components of an electric vehicle, in accordance with various embodiments;

FIG. 4 illustrates a flow diagram of further operations of the allocation of minimum power to various thermal components based on those thermal components that are active, in accordance with various embodiments;

FIG. 5 illustrates a flow diagram of further operations of allocation of power based on power consumed by both a thermal component and a growth buffer to allow for power increases, in accordance with various embodiments;

FIGS. 6A and 6B illustrate a flow diagram of further operations of allocation of any excess power (remaining power based on power budget from VCM), evenly across all active thermal components, in accordance with various embodiments;

FIG. 7 illustrates a flow chart illustrating a method for commanding active thermal components of an FCEV, in accordance with various embodiments; and

FIG. 8 illustrates a block diagram of a control logic for a thermal management system, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, electrical, or mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

For example, in the context of the present disclosure, methods, systems, and articles may find particular use in connection with BEVs, FCEVs, compressed natural gas (CNG) vehicles, hythane (mix of hydrogen and natural gas) vehicles, and/or the like. As used herein, “vehicle” may refer to a light-duty, medium duty, or heavy-duty commercial vehicle, passenger vehicle, or any other vehicle. However, various aspects of the disclosed embodiments may be adapted for performance in a variety of other systems. Further, in the context of the present disclosure, methods, systems, and articles may find particular use in any system requiring use of a battery, fuel cell, and/or electrical, thermal, or other control or management system of the same. As such, numerous applications of the present disclosure may be realized.

While the principles of the present disclosure are discussed mainly in relation to high-voltage components and systems, it should be appreciated that the principles described herein may also apply to low-voltage components/systems, for example, pumps and blower fans. As referred to herein, “high-voltage” means an electric component or circuit having a working voltage of at least 100 V, at least 200 V, at least 400 V, or at least 800 V. As referred to herein, “low-voltage” means an electric component or circuit having a working voltage of up to 100 V, up to 200 V, up to 400 V, or up to 800 V. Moreover, while discussed in relation to thermal system components for vehicles, it should be appreciated the principles of the present disclosure may be implemented in any system where power is limited based on the needs of power consumers.

Principles of the present disclosure may be compatible with and/or desirably utilized in connection with concepts disclosed in any of the following applications: (i) U.S. patent application Ser. No. 17/938,741 filed on Oct. 7, 2022, now U.S. Patent Application Publication No. 2023-0364962 A1 entitled “Integrated Thermal Management System”; (ii) U.S. patent application Ser. No. 18/465,234 filed on Sep. 12, 2023, now U.S. Pat. No. 12,095,061 entitled “Systems and Methods for Electric Vehicle Powertrain Thermal Management and Control”; (iii) U.S. patent application Ser. No. 18/301,791 filed on Apr. 17, 2023, now U.S. Patent Application Publication 2023-0271512 A1 entitled “High Voltage Battery Conditioning for Battery Electric Vehicle”; (iv) U.S. patent application Ser. No. 18/322,283 filed on May 23, 2023, now U.S. Patent Application Publication No. 2023-0365026 A1 entitled “Fuel Cell Thermal Management Controls Systems and Methods”; and/or (v) U.S. patent application Ser. No. 18/752,993 filed on Jun. 25, 2024 entitled “Power Control Planning and Optimization for Hybrid Vehicles.” The disclosures of the foregoing applications are hereby incorporated by reference herein in their entirety, including but not limited to those portions that specifically appear hereinafter, but except for any subject matter disclaimers, or disavowals, and except to the extent that the incorporated material is inconsistent with the express disclosure herein, in which case the language in this disclosure shall control.

Typically, FCEVs are configured with a fuel cell stack and a high-voltage battery. Power to operate the FCEV may come from the fuel cell stack, the high-voltage battery, or combination thereof. The total amount of power available to an FCEV at a given time may be understood to be the maximum power output of the fuel cell stack plus the maximum power output of the high-voltage battery. For example, an FCEV may be configured with a fuel cell stack or stacks having a maximum sustained power output of about 150 kW, and a high-voltage battery capable of providing about 75 kW of maximum power output, for a combined maximum power output of about 225 kW. It will be appreciated that the high-voltage battery will eventually need to be recharged (for example, with electric current obtained from regenerative braking, from electric current output from the fuel cell stack, or the like). Power generation, storage, and/or distribution for an FCEV may vary when the FCEV is operating under adverse conditions, such as when the FCEV is ascending a steep grade, i.e., a mountain. Moreover, in these or other conditions, the amount of power requested by all FCEV systems may exceed the amount of power available. For example, an FCEV capable of supplying 225 kW of power may encounter a scenario where FCEV systems collectively request 300 kW of power for preferred operation. In such adverse conditions, certain operation decisions may be implemented to prioritize power delivered to the various components within the FCEV, for example in order to maintain proper and safe operation of the FCEV. The above may be equally true for low-voltage power supply and consumers.

In various embodiments, with regard to heating and cooling of certain high-voltage components within the FCEV, it may be advantageous to tailor a prioritization of power delivered to heating and cooling of such high-voltage components in the FCEV. That is, various high-voltage components of FCEVs may operate optimally when within a determined temperature range. In that regard, in FCEVs, while heating and cooling of these various high-voltage components are both desired, in some embodiments heating may be prioritized over cooling. Additionally, with regard to various high-voltage components that operate optimally when within a predetermined temperature range, in various embodiments, heating and/or cooling of the fuel cell stack may be prioritized first because the commercial FCEV may not operate if the fuel cell stack is frozen, including in battery only mode. In various embodiments, heating and/or cooling of the batteries may be prioritized second because the FCEV may operate on batteries only from time to time, for example, when fuel is no longer available, or the fuel cell stack inoperable. In various embodiments, cooling of the high-voltage electronics, for example inverters, may be prioritized third to enable the drivetrain to operate, and cooling of the drivetrain may be prioritized fourth. In various embodiments, brake resistor cooling may be prioritized fifth, and heating, ventilation, and air-conditioning (HVAC) of the driver may be prioritized last. Further, since heating may be prioritized over cooling in some embodiments, there may be times when heating of a lower prioritized thermal component may be prioritized over cooling of a higher prioritized thermal component.

In various embodiments, a thermal management module (TMM) within the FCEV may manage power distribution to the various thermal components, for example the components providing heating and/or cooling of the high-voltage components, within the FCEV. In various embodiments, a vehicle control module (VCM) communicates a power budget to the TMM at regular intervals. In various embodiments, TMM and VCM may be in electrical, wireless, and/or logical communication with each other and/or the high-voltage components. In various embodiments, the functions of TMM and VCM may be accomplished by a single controller or more than two controllers. In various embodiments, the regular intervals may be between every 50 milliseconds (ms) and 150 ms. In various embodiments, the regular intervals may be between every 75 ms and 125 ms. In various embodiments, the regular interval may be every 100 ms. In that regard, the TMM determines a power distribution for the various thermal components at regular intervals. In various embodiments, the regular intervals may be between every 50 ms and 150 ms. In various embodiments, the regular intervals may be between every 75 ms and 125 ms. In various embodiments, the regular interval may be every 100 ms. In various embodiments, the power budget may be based at least in part on power available on an HV bus and determined based at least in part on a high-voltage battery state of charge (SOC).

In various embodiments, a maximum power budget for the various thermal components may be between 50 kW and 100 kW. In various embodiments, a maximum power budget for the thermal components may be between 65 kW and 85 kW. In various embodiments, a maximum power budget for the thermal components may be 72 kW. In various embodiments, in response to the maximum power budget being, for example, 72 kW, each high-voltage thermal component may operate at maximum power. However, responsive to the maximum power budget being lower, for example due to adverse conditions, i.e., when power is needed elsewhere in the FCEV (such as when the FCEV is, for example, ascending a steep grade), then the TMM determines power allocation to the thermal components based on a predetermined prioritization. In various embodiments, the power provided to each of the thermal components may be allocated based on a predetermined allocation process. In various embodiments, it will be appreciated that even if the TMM allocates a maximum power of the component to the given component, instantaneous power allocation may be less. Stated otherwise, in some situations (such as when the VCM indicates there is more power available for thermal functions than is needed), more power may be allocated to a given component than is necessary to operate the component based on current needs (e.g., maximum power may be allocated to a component even though such component only requires 30%, 40%, 50%, etc. of the maximum power based on current heating/cooling requirements). Moreover, in various embodiments, in no event will the TMM allocate more power to a thermal component greater than the thermal component's maximum power rating.

In order to achieve these and/or other objectives, and to provide for improved safety, modularity, control, and/or management of thermal components of an FCEV, principles of the present disclosure contemplate use of exemplary systems and methods as disclosed herein.

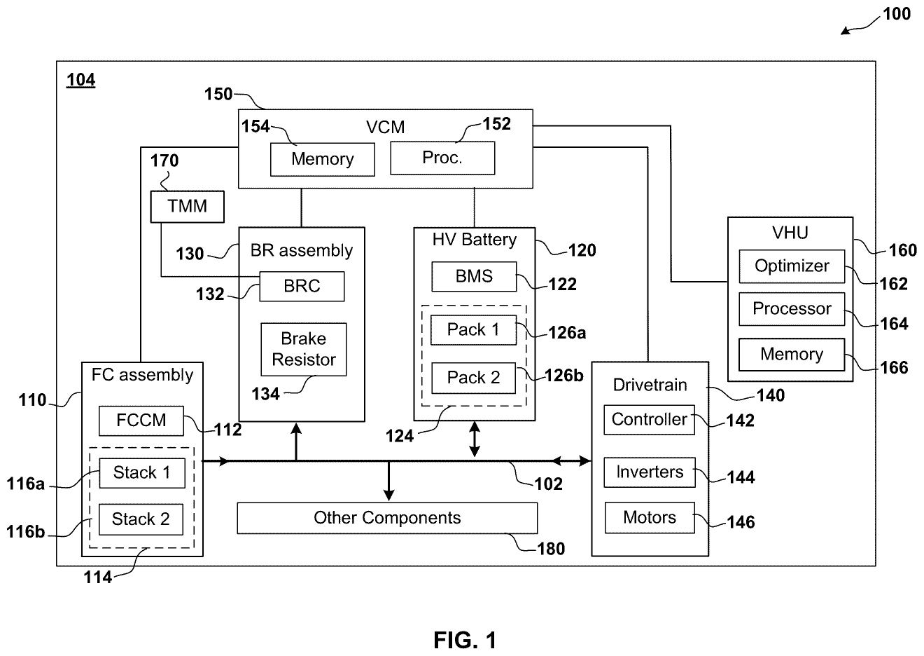

Referring now to FIG. 1, a power control system 100 for use in an FCEV is illustrated, in accordance with various embodiments. Power control system 100 includes a high voltage (HV) bus 102, a fuel cell (FC) assembly 110, a high-voltage (HV) battery assembly 120, a brake resistor (BR) assembly 130, a drivetrain 140, a VCM 150, a vehicle head unit (VHU) 160, a TMM 170, and other components 180. As described herein, power control system 100 may be used to operate a vehicle 104. FC assembly 110, HV battery assembly 120, BR assembly 130, drivetrain 140, and other components 180 are electrically coupled to each other by HV bus 102. That is, HV bus 102 transmits high voltage DC power between the various high voltage assemblies in power control system 100. Other components 180 includes the various electrically powered components of vehicle 104 and may include, in various embodiments, an air-conditioning system, a cooler system, a fan, one or more power converters, and the various other electrical components of vehicle 104, among others.

In various embodiments, FC assembly 110 is the primary power source within power control system 100. FC assembly 110 outputs power to charge HV battery assembly 120, power drivetrain 140, and power other components 180. FC assembly 110 includes a fuel cell control module (FCCM) 112 and a fuel cell (FC) 114 including a first FC stack 116a and a second FC stack 116b. First FC stack 116a and second FC stack 116b are the power sources of FC 114. In various embodiments, first FC stack 116a and second FC stack 116b may provide the same amount of power, within a tolerance range (e.g., +−5%). In various embodiments, first FC stack 116a may provide more power than second FC stack 116b, and vice versa. In various embodiments, FC 114 may include one or more FC stacks. For ease of discussion, and for illustration purposes, two FC stacks (i.e., first FC stack 116a and second FC stack 116b) that are similarly sized (i.e., about the same output power) will be discussed below. However, it should be understood that fewer or more FC stacks may be used for various designs, and the size of the stacks may differ from one another.

First FC stack 116a and second FC stack 116b, collectively referred to below as FC stacks 116, are electrochemical cells that convert a chemical energy in a fuel (e.g., hydrogen) and an oxidizing agent (e.g., oxygen) into electricity through redox reactions. That is, electricity, or power, is generated by the oxidizing of the fuel within each FC stack 116. FC stacks 116 have a maximum power output and an effective minimum power output. The maximum power output of FC stacks 116 may vary depending on various design factors including size, thermal capacity, fuel consumption, type of fuel, ambient temperature, and fuel supply pressure, among others. In various embodiments, the maximum power output of FC stacks 116 may be about 50 kW to about 400 kW, or more. The effective minimum power output is the minimum power output available while FC stacks 116 are running. In various embodiments, the effective minimum power output may be about 5 kW to about 30 kW, or more.

The power output of FC assembly 110, and fuel cells in general, may be affected by various factors including altitude and operating temperature. Generally, fuel cells begin to lose peak power (e.g., have a lower peak power) when operating at higher altitudes. While ambient temperature does not generally affect fuel cell power output, the operating temperature of the fuel cell does affect the power output. Generally, fuel cells operate normally (e.g., optimal power output and efficiency) when kept at or below a preferred operating temperature. In various the preferred operating temperature may be about 50° C. to about 70° C. For ease of discussion below, the preferred operating temperature of FC stacks 116 will be described as being about 60° C. Power output management will be discussed in further detail below.

HV battery assembly 120 is the tank for energy storage in power control system 100. As such, HV battery assembly 120 is capable of receiving power from the system (e.g., FC assembly 110) and providing power to the system (e.g., drivetrain 140). That is, HV battery assembly 120 may be a sink for power or a source of power depending on what other components (e.g., FC assembly 110, BR assembly 130, drivetrain 140, etc.) are doing. HV battery assembly 120 is capable of providing power to HV bus 102 at the same time that FC assembly 110 is providing power to HV bus 102. This allows for a boost in power above what either HV battery assembly 120 or FC assembly 110 is capable of providing on their own. HV battery assembly 120 includes a battery management system (BMS) 122 and an HV battery 124 that includes a first battery pack, first pack 126a, and a second battery pack, second pack 126b.

First pack 126a and second pack 126b are the power storage of HV battery 124. In various embodiments, first pack 126a and second pack 126b may store the same amount of power, source the same voltage, and source the same current, within a tolerance range (e.g., +−5%). In various embodiments, first pack 126a may store more power and/or source more voltage and current than second pack 126b, or vice versa. In various embodiments, HV battery 124 may include one or more battery packs. For ease of discussion, and for illustration purposes, two battery packs (i.e., first pack 126a and second pack 126b) that are similarly sized (i.e., about the same storage and power output capabilities) will be discussed below. However, it should be understood that fewer or more battery packs may be used for various designs, such as three battery packs, four battery packs, nine battery packs, and/or the like.

First pack 126a and second pack 126b, collectively referred to below as packs 126, are power storage devices including one or more electrochemical cells for storing and providing power. In various embodiments, packs 126 may include any type of rechargeable battery suitable for the design including lithium ion, lithium iron phosphate, silver oxide, or nickel zinc, among other types of batteries. Stated another way, packs 126 may be any type of battery that can be used multiple times. Packs 126 have a total capacity, a total energy, a voltage, a nominal voltage, a peak discharge rate, a continuous discharge rate, and a peak recharge, or regen, rate. The values for each of these may vary depending on various design factors including composition, size, ambient temperature, and use, among others. In various embodiments, the voltage of packs 126 may be about 300 V to about 900 V, and more specifically, about 450 V-756 V. In various embodiments, the nominal voltage of packs 126 may be about 450 V to about 800 V, and more specifically, about 660 V. Other voltage and nominal voltage ranges and values are possible, depending on the system and design of the battery pack. In various embodiments, the total capacity of packs 126 may be about 100 Ah to about 200 Ah, and more specifically about 120 Ah. In various embodiments, the total energy stored in packs 126 may be about 75 kilowatt-hours (kWh) to about 200 kWh, and more specifically about 82 kWh. Other capacity and energy ranges and values are possible depending on the system and the design of the battery pack.

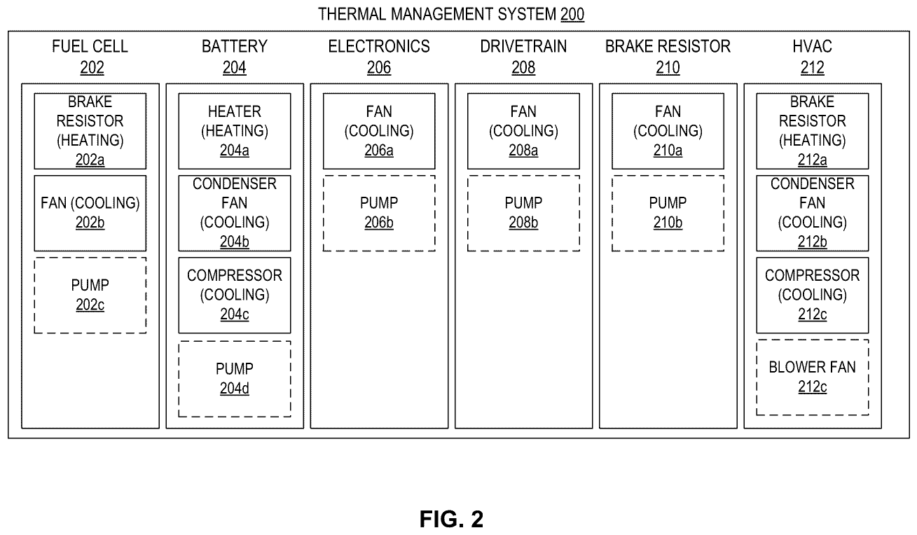

Referring now to FIG. 2, a functional block diagram of a thermal management system for an FCEV is illustrated, in accordance with various embodiments. In various embodiments, thermal management system 200 may manage heating and cooling of one or more components, including fuel cell 202 (i.e. fuel cell (FC) assembly 110 of FIG. 1), battery 204 (i.e. high voltage (HV) battery assembly 120 of FIG. 1, high-voltage electronics 206, drivetrain 208 (i.e. drivetrain 140 of FIG. 1), brake resistor 210 (i.e. brake resistor (BR) assembly 130 of FIG. 1), and heating, ventilation, and air-conditioning (HVAC) 212 for the driver of the FCEV, among others.

In various embodiments, heating and/or cooling of fuel cell 202 may include brake resistor 202a for heating, fan 202b for cooling, and pump 202c. In various embodiments, heating and/or cooling of battery 204 may include heater 204a for heating, condenser fan 204b for cooling, compressor 204c for cooling, and pump 204d. In various embodiments, cooling of high-voltage electronics 206 may include fan 206a for cooling and pump 206b. In various embodiments, cooling of drivetrain 208 may include fan 208a for cooling and pump 208b. In various embodiments, cooling of brake resistor 210 may include fan 210a for cooling and pump 210b. In various embodiments, heating and/or cooling for HVAC 212 may include brake resistor 212a for heating, condenser fan 212b for cooling, compressor 212c for cooling, and blower fan 212d. As illustrated in FIG. 2, high-voltage thermal components are identified with solid outlines and low-voltage components are identified with dashed outlines.

As stated previously, one or more of these components may operate optimally when within a determined temperature range. In that regard, in FCEVs, while heating and cooling are both desired, in certain operating circumstances, heating may be prioritized over cooling. In that regard, in various embodiments, power to brake resistor 202a is prioritized first, followed by power to heater 204a for heating of the battery 204 second, and power to fan 206a for cooling of the high-voltage electronics 206 third. In various embodiments, power to fan 208a for cooling of the drivetrain 208 is prioritized fourth, followed by power to compressor 204b for cooling of the battery 204 fifth, and power to fan 210a for cooling of the brake resistor 210 sixth. In various embodiments, power to the fan 202b for cooling of the fuel cell 202 is prioritized seventh, followed by power to the brake resistor 212a for heating of the HVAC 212 prioritized eighth, and power to the condenser fan 212b for cooling of the HVAC 212 prioritized ninth. In various embodiments, power to the compressor 212c for cooling of the HVAC 212 is prioritized tenth.

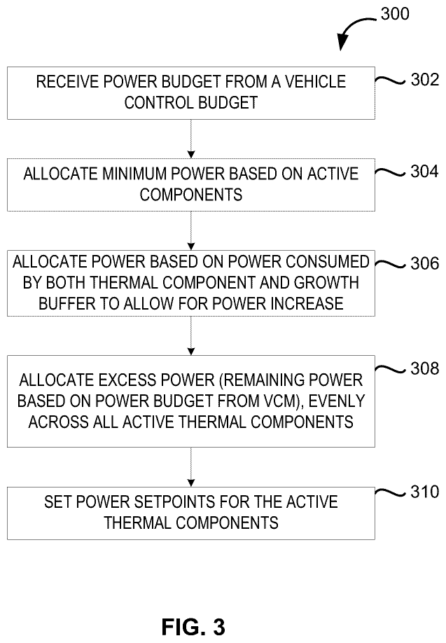

Referring now to FIG. 3, a high-level flow diagram of a method 300 for managing power distribution to the various thermal components of an electric vehicle, such as vehicle 104 as shown in FIG. 1 (and/or thermal components of thermal management system 200 of FIG. 2), is illustrated, in accordance with various embodiments. As stated previously, the thermal management module (TMM), such as TMM 166 of FIG. 1, within the FCEV may manage the power distribution to the various thermal components, i.e., the components utilizing heating and/or cooling. At block 302, the TMM receives a power budget communication from a vehicle control module (VCM). In various embodiments, the power budget may be based on power available on high-voltage bus and determined based, at least in part, on battery (for example, battery 204 of FIG. 2) state of charge (SOC). In various embodiments, a maximum power budget for the various thermal components may be between 50 kW and 100 kW. In various embodiments, a maximum power budget for the thermal components may be between 65 kW and 85 kW. In various embodiments, a maximum power budget for the thermal components may be 72 kW. In various embodiments, in response to the maximum power budget being, for example, 72 kW, each high-voltage thermal component may operate at maximum power. At block 304, the TMM allocates minimum power to the various thermal components based on those thermal components that are active (i.e., those thermal components that are required to operate to meet current heating or cooling needs). At block 306, the TMM allocates power based on power consumed by both the thermal component and a growth buffer to allow for power increases. In various embodiments, the growth buffer may be based upon empirical data indicative of common power fluctuations for each component. In various embodiments, the growth buffer may be a predetermined percentage (i.e., 10%, 20%, etc.) of the maximum power for each component. In various embodiments, the growth buffer may be based upon, in part, the anticipated power demands of the component given anticipated operational requirements. At block 308, the TMM allocates any excess power (remaining power based on power budget from VCM), evenly across all active thermal components. At block 310, the TMM sets power setpoints for the active thermal components.

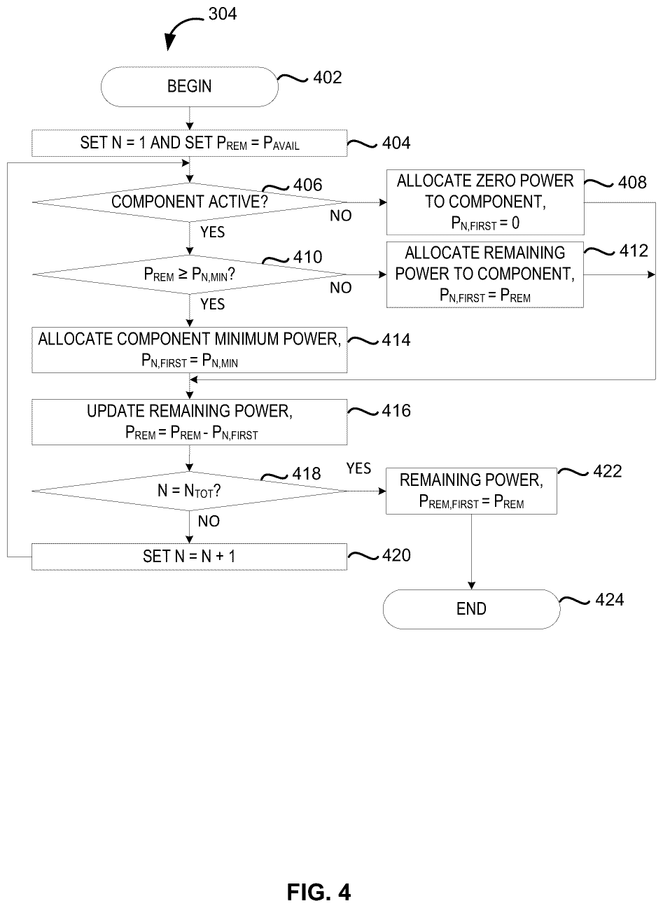

Referring now to FIG. 4, a flow diagram of a method 304 of further operations of the allocation of minimum power to the various thermal components based on those thermal components that are active is illustrated, in accordance with various embodiments. For the thermal components of the FCEV and based on the predefined priority list, such as the priority list identified in FIG. 2, method 304 begins at block 402. At block 404, the TMM initially sets an incremental number (N) variable to 1, i.e., N=1, and sets a power remaining (P_{REM}) to the power available (P_{AVAIL}), i.e., P_{REM}=P_{AVAIL}, the power budget communicated from the VCM based on power available on high-voltage bus and determined based on battery state of charge (SOC). In various embodiments, P_{AVAIL} may correlate to the amount of power available to the high-voltage thermal components after subtracting power allocations to other systems required to operate the FCEV (e.g., electric motor demand based on requested torque). In various embodiments, P_{AVAIL} may be determined based on power available on the low-voltage bus rather than the high-voltage bus. At block 406, the TMM determines whether the thermal component is active. Stated otherwise, TMM determines whether the operation of the thermal component is required based on current and/or anticipated heating or cooling needs. If at block 406 the TMM determines that the thermal component is not active, at block 408, the TMM allocates a zero point to the thermal component's first power allocation (P_{N,FIRST}), i.e., P_{N,FIRST}=0. If at block 406 the TMM determines that the thermal component is active, at block 410, the TMM determines whether the power remaining (P_{REM}) is greater than or equal to the component's minimum operating power (P_{N,MIN}). If at block 410 the TMM determines that the power remaining (P_{REM}) is less than the component's minimum operating power (P_{N,MIN}), at block 412, the TMM allocates the power remaining (P_{REM}) to the thermal component, i.e., P_{N,FIRST}=P_{REM}.

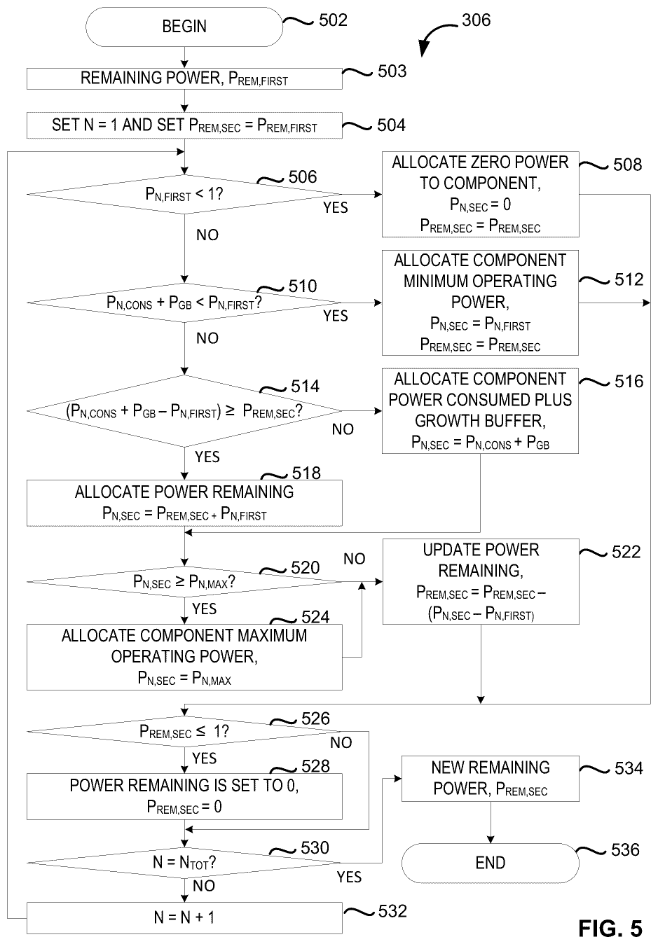

If at block 410 the TMM determines that the power remaining (P_{REM}) is greater than or equal to the component's minimum operating power (P_{N,MIN}), at block 414, the TMM allocates the thermal component's minimum power to the thermal component, i.e., P_{N,FIRST}=P_{N,MIN}. At block 416, the TMM then updates the power remaining (P_{REM}) to the power remaining (P_{REM}) minus the allocated P_{N,FIRST}, i.e. P_{REM}=P_{REM}−P_{N,FIRST}. At block 418, the TMM determines whether the incremental number (N) is equal to the total number of high voltage components (N_{TOT}). If at block 418 the number N fails to be equal to the total number of high voltage components (N_{TOT}), at block 420, the TMM increments the incremental number (N) by 1, i.e. N=N+1, with the operation returning to block 406 thereafter. If at block 418 the number N equals the total number of high voltage components (N_{TOT}), at block 422, the TMM sets the power remaining after all first power allocations (P_{REM,FIRST}) based on active components to the power remaining (P_{REM}), i.e. P_{REM},FIRST=P_{REM}, with the method 304 ending at block 424. In various embodiments, block 424 may initiate other methods, for example, method 306 of FIG. 5 discussed below.

Referring now to FIG. 5, a flow diagram of a method 306 of further operations of the allocation of power based on power consumed by both the thermal component and a growth buffer to allow for power increases is illustrated, in accordance with various embodiments. For the thermal components of the FCEV and based on the predefined priority list, such as the priority list identified in FIG. 2, method 306 begins at block 502. At block 503, the TMM identifies the power remaining after all first power allocations (P_{REM,FIRST}) from step 422 of FIG. 4. At block 504, the TMM sets an incremental number (N) variable to 1, i.e., N=1, and sets a power remaining for second power allocations (P_{REM,SEC}) equal to the power remaining after all first power allocations (P_{REM,FIRST}), i.e., P_{REM,SEC}=P_{REM,FIRST}.

At block 506, the TMM determines whether the thermal component's first power allocation (P_{N,FIRST}) is less than 1 watt, i.e., P_{N,FIRST}<1. If at block 506 the TMM determines that the thermal component's first power allocation (P_{N,FIRST}) is less than 1 watt, at block 508, the TMM allocates zero power to the thermal component's second power allocation (P_{N,SEC}), i.e., P_{N,SEC}=0. As a result, the power remaining for second power allocations remains unchanged, i.e., P_{REM,SEC}=P_{REM,SEC}. If at block 506 the TMM determines that the thermal component's first power allocation (P_{N,FIRST}) is greater than or equal to 1 watt, at block 510, the TMM determines whether the component power consumption (P_{N,CONS}) plus the power growth buffer (P_{GB}) is less than the thermal component's first power allocation (P_{N,FIRST}), i.e., P_{N,CONS}+P_{GB}<P_{N,FIRST}. If at block 510 the TMM determines that the component power consumption (P_{N,CONS}) plus the power growth buffer (P_{GB}) is less than the thermal component's first power allocation (P_{N,FIRST}), at block 512, the TMM allocates a component minimum operating power, i.e., P_{N,SEC}=P_{N,FIRST}. As a result, the power remaining for second power allocations remains unchanged, i.e., P_{REM,SEC}=P_{REM,SEC}. If at block 510 the TMM determines that the component power consumption (P_{N,CONS}) plus the power growth buffer (P_{GB}) is greater than or equal to the thermal component's first power allocation (P_{N,FIRST}), at block 514 the TMM determines whether the component power consumption (P_{N,CONS}) plus the power growth buffer (P_{GB}) minus the thermal component's first power allocation (P_{N,FIRST}) is greater than or equal to the power remaining after second power allocations (P_{REM,SEC}), i.e., (P_{N,CONS}+P_{GB}−P_{N,FIRST})>P_{REM,SEC}.

If at block 514 the TMM determines that the component power consumption (P_{N,CONS}) plus the power growth buffer (P_{GB}) minus the thermal component's first power allocation (P_{N,FIRST}) is less than the power remaining after second power allocations (P_{REM,SEC}), at block 516, the TMM allocates the component power consumption (P_{N,CONS}) plus the power growth buffer (P_{GB}), i.e., P_{N,SEC}=P_{N,CONS}+P_{GB}. If at block 514 the TMM determines that the component power consumption (P_{N,CONS}) plus the power growth buffer (P_{GB}) minus the thermal component's first power allocation (P_{N,FIRST}) is greater than or equal to the power remaining after second power allocations (P_{REM,SEC}), at block 518, the TMM allocates the power remaining after second power allocations (P_{REM,SEC}) in addition to the thermal component's first power allocation (P_{N,FIRST}) as the thermal component's second power allocation (P_{N,SEC}), i.e., P_{N,SEC}=P_{REM,SEC}+P_{N,FIRST}.

From blocks 516 and 518, at block 520, the TMM determines whether the thermal component's second power allocation (P_{N,SEC}) is greater than or equal to the component's maximum operating power (P_{N,MAX}), i.e., P_{N,SEC}>P_{N,MAX}. If at block 520 the TMM determines that the thermal component's second power allocation (P_{N,SEC}) fails to be greater than or equal to the component's maximum operating power (P_{N,MAX}), at block 522, the TMM updates the power remaining after second power allocations (P_{REM,SEC}) to be equal to the power remaining after second power allocations (P_{REM,SEC}) minus the difference of the thermal component's second power allocation (P_{N,SEC}) and the thermal component's first power allocation (P_{N,FIRST}), i.e., P_{REM,SEC}=P_{REM,SEC}−(P_{N,SEC}−P_{N,FIRST}). If at block 520 the TMM determines that the thermal component's second power allocation (P_{N,SEC}) is greater than or equal to the component's maximum operating power (P_{N,MAX}), at block 524, the TMM allocates the component's maximum operating power as the thermal component's second power allocation (P_{N,SEC}), i.e., P_{N,SEC}=P_{N,MAX}, with the operation proceeding to block 522 thereafter.

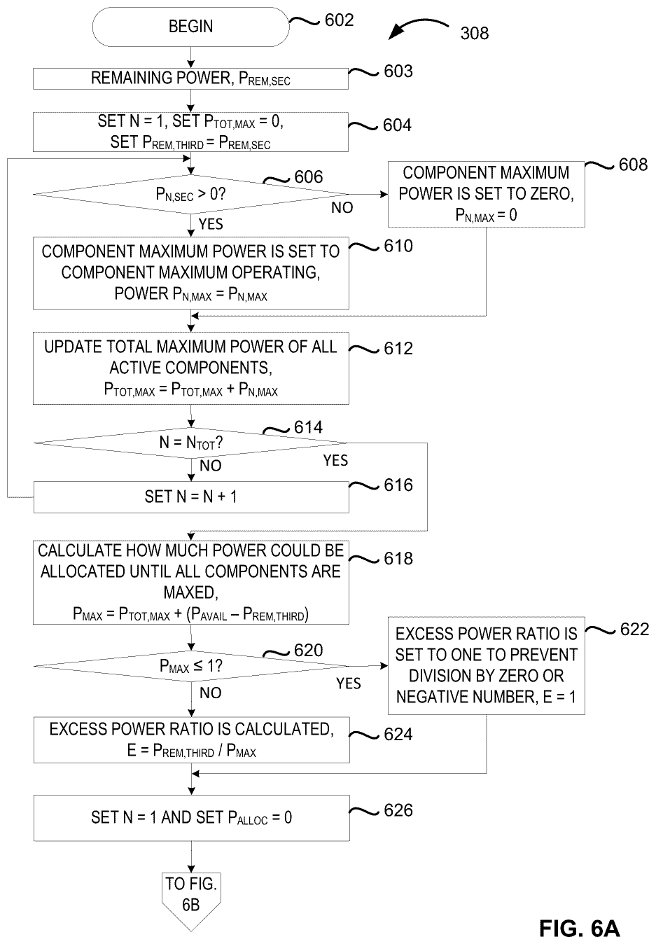

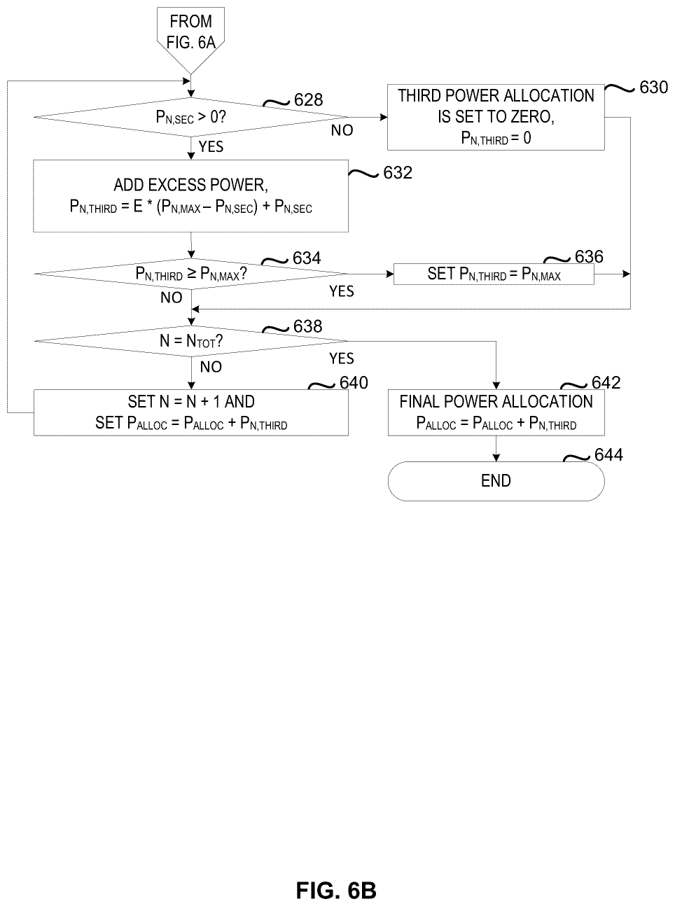

From blocks 508, 512, and 522, at block 526, the TMM determines whether the power remaining after second power allocations (P_{REM,SEC}) is less than or equal to 1 watt, i.e., P_{REM,SEC}≤1. If at block 526 the TMM determines that the power remaining after second power allocations (P_{REM,SEC}) is less than or equal to 1 watt, at block 528, the TMM sets the power remaining after second power allocations (P_{REM,SEC}) equal to zero, i.e., P_{REM,SEC}=0. From block 528 or if at block 526 the TMM determines that the power remaining after second power allocations (P_{REM,SEC}) fails to be less than or equal to 1, at block 530, the TMM determines whether the incremental number (N) is equal to the total number of high voltage components (N_{TOT}). If at block 530 the TMM determines that the number N fails to be equal to the total number of high voltage components (N_{TOT}), at block 532, the TMM increments the incremental number (N) by 1, i.e., N=N+1, with the operation returning to block 506 thereafter. If at block 530 the number N equals the total number of high voltage components (N_{TOT}), at block 534, the TMM sets the new power remaining to the power remaining after all second power allocations (P_{REM,SEC}), with the method 306 ending at block 536. In various embodiments, block 536 may initiate other methods, for example, method 308 of FIG. 6A discussed below.

Referring now to FIGS. 6A and 6B, a flow diagram of a method 308 of further operations of the allocation of any excess power (remaining power based on power budget from VCM), evenly across all active thermal components is illustrated, in accordance with various embodiments. For the thermal components of the FCEV and based on the predefined priority list, such as the priority list identified in FIG. 2, the method 308 begins at block 602. At block 603, the TMM identifies the power remaining after all second power allocations (P_{REM,SEC}) from block 534 of FIG. 5. At block 604, the TMM initially sets an incremental number (N) variable to 1, i.e., N=1, sets a total maximum power of all active components (P_{TOT,MAX}) to zero, i.e., P_{TOT,MAX}=0, and sets a power remaining after third power allocations (P_{REM,THIRD}) equal to the power remaining after all second power allocations (P_{REM,SEC}), i.e. P_{REM,THIRD}=P_{REM,SEC}.

At block 606, the TMM determines whether the thermal component's second power allocation (P_{N,SEC}) is greater than 0, i.e., P_{N,SEC}>0. If at block 606 the TMM determines that the thermal component's second power allocation (P_{N,SEC}) fails to be greater than 0, at block 608, the TMM sets the thermal component's maximum power (P_{N,MAX}) equal to zero, i.e., P_{N,MAX}=0. If at block 606 the TMM determines that the thermal component's second power allocation (P_{N,SEC}) is greater than 0, at block 610, the TMM sets the thermal component's maximum power (P_{N,MAX}) equal to the thermal component's maximum power (P_{N,MAX}), i.e., P_{N,MAX}=P_{N,MAX}. In various embodiments, the thermal component's maximum power (P_{N,MAX}) may correlate to the component's maximum rated operating power. From blocks 608 and 610, at block 612, the TMM updates the total maximum power of all active components (P_{TOT,MAX}) to a sum of the total maximum power of all active components (P_{TOT,MAX}) considered previously and the current thermal component's maximum power (P_{N,MAX}), i.e., P_{TOT,MAX}=P_{TOT,MAX}+P_{N,MAX}. At block 614, the TMM determines whether the incremental number (N) is equal to the total number of high-voltage components (N_{TOT}). If at block 614 the TMM determines that the number N fails to be equal to the total number of high voltage components (N_{TOT}), at block 616, the TMM increments the incremental number (N) by 1, i.e., N=N+1, with the operation returning to block 606 thereafter. If at block 614 the number N equals the total number of high voltage components (N_{TOT}), at block 618, the TMM calculates how much power could be allocated until all thermal components are maxed (P_{MAX}) by adding the total maximum power of all active components (P_{TOT,MAX}) to the difference of the power available (P_{AVAIL}) and the power remaining after all third power allocations (P_{REM,THIRD}), P_{MAX}=P_{TOT,MAX}+(P_{AVAIL}−P_{REM,THIRD}). At block 620, the TMM determines whether the power that could be allocated until all thermal components are maxed (P_{MAX}) is less than or equal to 1 watt, P_{MAX}<1. If at block 620 the power that could be allocated until all thermal components are maxed (P_{MAX}) is less than or equal to 1 watt, at block 622, the TMM sets an excess power ratio (E) to one to prevent division by zero or a negative number, i.e., E=1. If at block 620 the power that could be allocated until all thermal components are maxed (P_{MAX}) fails to be less than or equal to 1 watt, at block 624, the TMM calculates the excess power ratio (E) by dividing the power remaining after all third power allocations (P_{REM,THIRD}) by the power that could be allocated until all thermal components are maxed (P_{MAX}), i.e., E=P_{REM,THIRD}/P_{MAX}.

At block 626, the TMM sets the incremental number (N) to 1, i.e., N=1, and sets a total allocated power (P_{ALLOC}) to zero, i.e., P_{ALLOC}=0. At block 628, the TMM determines whether the thermal component's second power allocation (P_{N,SEC}) is greater than zero, i.e., P_{N,SEC}>0. If at block 628 the TMM determines that the thermal component's second power allocation (P_{N,SEC}) fails to be greater than zero, at block 630, the TMM sets the thermal component's third power allocation (P_{N,THIRD}) to zero, i.e., P_{N,THIRD}=0. If at block 628 the TMM determines that the thermal component's second power allocation (P_{N,SEC}) is greater than zero, at block 632, the TMM adds excess power, such that the thermal component's third power allocation (P_{N,THIRD}) is equal to the excess power ratio (E) times a difference of the thermal component's maximum power (P_{N,MAX}) and the thermal component's second power allocation (P_{N,SEC}). This value is then added to the thermal component's second power allocation (P_{N,SEC}) to obtain the component's third power allocation (P_{N,THIRD}), i.e., P_{N,THIRD}=E (P_{N,MAX}−P_{N,SEC})+P_{N,SEC}.

At block 634, the TMM determines whether the thermal component's third power allocation (P_{N,THIRD}) is greater than or equal to the thermal component's maximum power (P_{N,MAX}), i.e., P_{N,THIRD}>P_{N,MAX}. If at block 634 the TMM determines that the thermal component's third power allocation (P_{N,THIRD}) is greater than or equal to the thermal component's maximum power (P_{N,MAX}), at block 636 the TMM sets the thermal component's third power allocation (P_{N,THIRD}) equal to the thermal component's maximum power (P_{N,MAX}). If at block 634 the TMM determines that the thermal component's third power allocation (P_{N,THIRD}) fails to be greater than or equal to the thermal component's maximum power (P_{N,MAX}) and from blocks 630 and 636, at block 638 the TMM determines whether the incremental number (N) is equal to the total number of high-voltage components (N_{TOT}). If at block 638 the TMM determines that the number N fails to be equal to the total number of high voltage components (N_{TOT}), at block 640, the TMM increments the incremental number (N) by 1, i.e., N=N+1, and sets the total allocated power (P_{ALLOC}) equal to a sum of the total allocated power (P_{ALLOC}) and the thermal component's third power allocation (P_{N,THIRD}), with the operation returning to block 628 thereafter. If at block 638 the TMM determines that the number N is equal to the total number of high voltage components (N_{TOT}), at block 642, the TMM determines the final power allocation P_{ALLOC} to a sum of the total allocated power (P_{ALLOC}) and the thermal component's third power allocation (P_{N,THIRD}), with the method 308 ending at block 644.

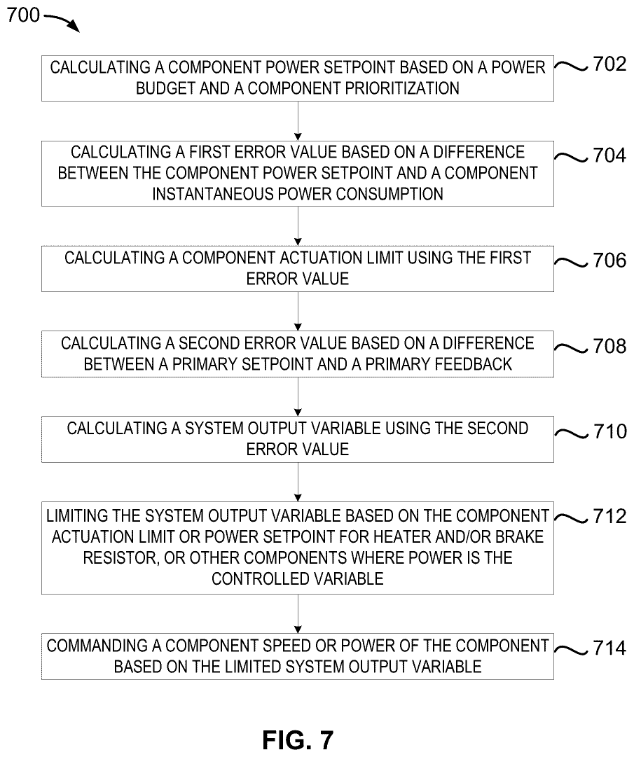

With reference now to FIG. 7, a flow chart illustrating a method 700 for commanding active thermal components of an FCEV is illustrated, in accordance with various embodiments. Method 700 may comprise calculating a component power setpoint based on a power budget and a component prioritization (step 702). In various embodiments, calculating the component power setpoint may comprise preforming the steps outlined in relation to methods 300, 304, 306, and 308 described above. Method 700 may further comprise calculating a first error value based on a difference between the component power setpoint and a component instantaneous power consumption (step 704). Method 700 may further comprise calculating a component actuation limit using the first error value (step 706). Method 700 may further comprise calculating a second error value based on a difference between a primary setpoint and a primary feedback (step 708). Specifically, in various embodiments, the primary setpoint and/or primary feedback may be related to the pressure and/or temperature of the system where pressure and/or temperature is being controlled (e.g., pressure and/or temperature of the coolant responsible for thermally regulating fuel cell 202, battery 204, HVAC 212, among others). In that regard, in various embodiments, the primary setpoint and/or primary feedback may be a coolant temperature, component temperature, and/or system temperature, among others. Further, in that regard, in various embodiments, the primary setpoint is the desired pressure and/or temperature and the primary feedback is a measured pressure and/or temperature at given time. Method 700 may further comprise calculating a system output variable using the second error value (step 710). Method 700 may further comprise limiting the system output variable based on the component actuation limit or power setpoint for heater and/or brake resistor, or other components where power is the controlled variable (as opposed to component speed, for example) (step 712). Method 700 may further comprise commanding a component speed or power of the component based on the limited system output variable (step 714).

In that regard, in various embodiments, power may be assigned or commanded to various components, such as brake resistor 210 of FIG. 2, in order to generate heat for other components, such as HVAC 212. That is, additional power assigned or commanded to the brake resistor results in additional heat being generated by the brake resistor, which may then be routed to other components. However, in various embodiments, power may be assigned or commanded to various other components, such as fan, 210a, 206a, 208a, or 210a, or condenser fan 212b, or compressors 204b or 212c, which results in an increased speed of the fan, condenser fan, or compressor. That is, components, such as fans increase in rotations per minute (RPM) based on an amount of current that is supplied. In various embodiments, a speed of such components may operate on a linear, stepwise, sinusoidal, or clipped, among others, basis based on the power supplied.

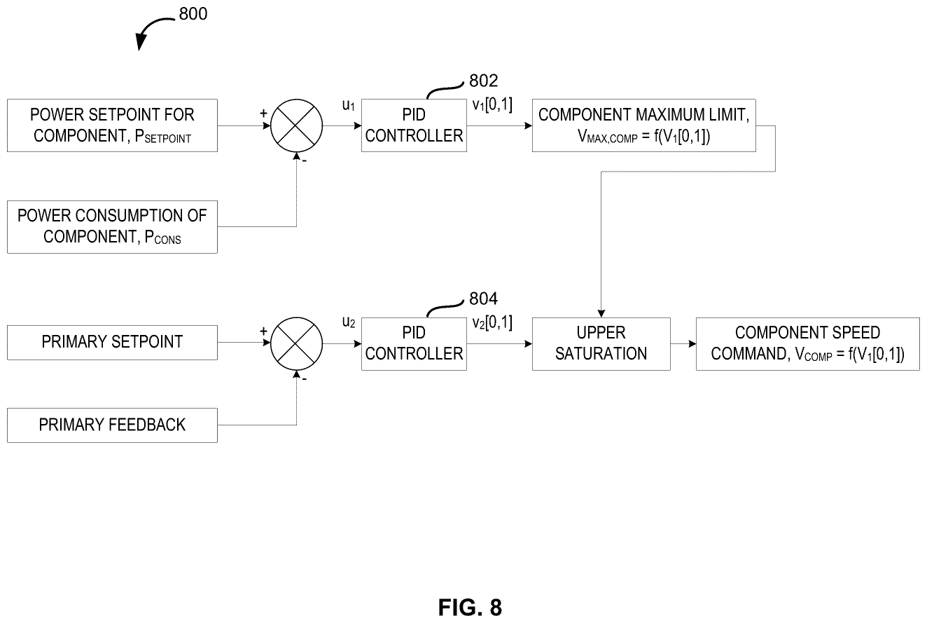

Referring now to FIG. 8, a block diagram of a control logic 800 for a thermal management system (e.g., thermal management system 170 of FIG. 1 or thermal management system 200 of FIG. 2) is illustrated, in accordance with various embodiments. Control logic 800 may implement a method (e.g., method 700 of FIG. 7) for commanding active thermal components of an FCEV. More particularly, control logic 800 may be used for calculating/commanding a component speed command for thermal components where speed is an adjusted variable, or alternatively, for calculating/commanding a component power for thermal components where power is an adjusted variable. The component speed command for thermal components where speed is an adjusted variable may be regulated by control logic 800 using a cascade PID controller based on pressure and/or temperature of the system where pressure and/or temperature is being controlled. The cascade controller may utilize two PID blocks in this case where a power setpoint for a component maximum limit is used as an upper saturation. In this manner, the speed of thermal components where speed is an adjusted variable may be regulated using a component speed command to meet the desired thermal requirements of the associated system (e.g., fuel cell 202, battery 204, HVAC 212, among others).

Control logic 800 may receive a power setpoint for a particular thermal component (P_{SETPOINT}) and a power consumption (P_{CONS}) for the particular thermal component. As indicated above, the power setpoint (P_{SETPOINT}) may be determined, in part, based on the steps described in relation to methods 300, 304, 306, and/or 308. Control logic 800 may calculate a difference between the particular thermal component (P_{SETPOINT}) and the power consumption (P_{CONS}), this difference referred to as a first error value (u₁). The difference (u₁) between the particular thermal component (P_{SETPOINT}) and the power consumption (P_{CONS}) may be used as the error value for a first PID controller 802. This error value (u₁) is minimized by the first PID controller 802 by adjusting and optimizing the output variable (v₁). Stated differently, control logic 800 may calculate a first output variable (v₁) using the first error value (u₁). The output variable (v1) is then used to compute a maximum velocity value (V_{MAX,COMP}) for the thermal component, i.e., V_{MAX,COMP}=f(V₁[0,1]). The maximum velocity value defines an upper limit for a second PID controller 804 which determines the final speed command.

Control logic 800 may further receive a primary setpoint and a primary feedback value of the thermal system. In some embodiments, the primary setpoint and the primary feedback value may be a coolant temperature or pressure associated with the system being thermally regulated (e.g., a coolant tasked with providing heat to and/or removing heat from fuel cell 202, battery 204, HVAC 212, among others). Control logic 800 may calculate a difference between the primary setpoint and the primary feedback value, this difference referred to as a second error value (u₂). The difference (u₂) between the primary setpoint and the primary feedback value may be used as the error value for the second PID controller 804. This error value (u₂) is minimized by the second PID controller 804 by adjusting and optimizing the output variable (v2). Stated differently, control logic 800 may calculate a second output variable (v2) using the second error value (u₂). Control logic 800 then calculates the component speed command, i.e., V_{COMP}=f(V₁[0,1]) based upon the second output variable (v2) and the upper saturation, i.e., the maximum velocity value (V_{MAX,COMP}), for the thermal component. Alternatively, where power is the controlled variable (for example, in the case of brake resistor 210), the power setpoint may be used as the upper saturation limit, thereby removing the need for first PID controller 802 and related logic. In such a way, the power and/or speed of the various thermal components of thermal management system 117 and/or 200 may be controlled/commanded in order to achieve a desired system coolant pressure/temperature in view of power constraints and/or component prioritization.

In various embodiments, a two-stage PID may removes need for transfer function between component power and component actuation variable (i.e., speed). In various embodiments, a two-stage PID may also reduce integral windup (excess overshooting) by implementing a speed limit. In various embodiments, a two-stage PID may further provide a feedback loop that compensates for unknown/unmeasurable disturbances (e.g., voltage delta, ram air, ambient temperature, or motor performance deterioration over time, among others) to ensure accurate control to the setpoint.

Via use of the exemplary systems and techniques disclosed herein, budgeting power for thermal systems ensures sufficient power is available for other vehicle functions (i.e., drivetrain). In various embodiments, by periodically adjusting the power budget based on instantaneous thermal needs, additional power may be used for motive power, thereby maximizing vehicle range. In various embodiments, by prioritizing/adjusting allocation to thermal components, thermal system efficiency may also be improved. In various embodiments, prioritization of power to thermal components enables the most important vehicle functions to operate when power budget for thermal applications is limited. In various embodiments, the systems and techniques disclosed herein may consider the need to propel the vehicle, safety, efficiency, durability, and/or driver comfort, among others. In various embodiments, power spikes and overcurrent conditions may be avoided that could lead to vehicle shutdown, i.e., batteries opening contactors if thermal system draws excessive power at a given time. In various embodiments, the systems and techniques disclosed herein may provide a groundwork for future development, i.e., allowing a “look ahead” power management based on characteristics of an anticipated route.

Computer programs (also referred to as computer control logic) are stored in main memory and/or secondary memory. Computer programs may also be received via communications interface. These computer program instructions may be loaded onto a general-purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PUP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for managing power distribution to a plurality of thermal components of a vehicle, the method comprising:
allocating, responsive to receiving a power budget and by a thermal management module (TMM), a first power allocation to each active thermal component of the plurality of thermal components;
allocating, by the TMM, a second power allocation to each active thermal component of the plurality of thermal components based on a power consumption of each active thermal component of the plurality of thermal components; and
allocating, by the TMM, a third power allocation to each active thermal component of the plurality of thermal components by equally distributing any excess power from the power budget following the first power allocations and the second power allocations.

2. The method of claim 1, wherein allocating, by the TMM, the second power allocation to each active thermal component further comprises:
allocating, by the TMM, additional power based on a power growth buffer associated with each active thermal component of the plurality of thermal components.

3. The method of claim 1, further comprising:
setting, by the TMM, a power setpoint for each active thermal component of the plurality of thermal components; and
commanding, by the TMM, a component power or a component speed for each active thermal component of the plurality of thermal components.

4. The method of claim 1, wherein allocating, by the TMM, the first power allocation to each active thermal component further comprises:
for each active thermal component of the plurality of thermal components based on a predetermined priority:
determining, by the TMM, whether a power remaining is greater than or equal to a minimum operating power of the active thermal component; and
responsive to determining that the power remaining is less than the minimum operating power of the active thermal component, allocating, by the TMM, the power remaining as the first power allocation to the active thermal component.

5. The method of claim 4, further comprising:
responsive to determining that the power remaining is greater than or equal to the minimum operating power of the active thermal component, allocating, by the TMM, the minimum operating power as the first power allocation to the active thermal component.

6. The method of claim 5, further comprising:
responsive to allocating the minimum operating power as the first power allocation to the active thermal component, updating, by the TMM, the power remaining to the power remaining minus the allocated minimum operating power; and
repeating the first power allocation for each active thermal component of the plurality of thermal components.

7. The method of claim 1, wherein allocating, by the TMM, the second power allocation to each active thermal component further comprises:
determining, by the TMM, whether the active thermal component's first power allocation is less than a first predetermined power value; and
responsive to determining that the active thermal component's first power allocation is less than the first predetermined power value, allocating, by the TMM, zero power as a second power allocation to the active thermal component.

8. The method of claim 7, further comprising:
responsive to determining that the active thermal component's first power allocation is greater than or equal to the first predetermined power value, determining, by the TMM, whether power consumption of the active thermal component plus a power growth buffer is less than the active thermal component's first power allocation; and
responsive to determining that the power consumption of the active thermal component plus the power growth buffer is less than the active thermal component's first power allocation, allocating, by the TMM, a minimum operating power as the second power allocation to the active thermal component.

9. The method of claim 8, further comprising:
responsive to determining that the power consumption of the active thermal component plus the power growth buffer is greater than or equal to the active thermal component's first power allocation, determining, by the TMM, whether the power consumption plus the power growth buffer minus the first power allocation of the active thermal component is greater than or equal to a power remaining after prior second power allocations; and
responsive to determining that the power consumption plus the power growth buffer minus the first power allocation of the active thermal component is less than the power remaining after the prior second power allocations, allocating, by the TMM, the power consumption plus the power growth buffer as the second power allocation to the active thermal component.

10. The method of claim 9, further comprising:
responsive to determining that the power consumption plus the power growth buffer minus the first power allocation of the active thermal component is greater than or equal to the power remaining after the prior second power allocations, allocating, by the TMM, the power remaining after the second power allocations in addition to the first power allocation of the active thermal component as the second power allocation to the active thermal component.

11. The method of claim 10, further comprising:
determining, by the TMM, whether the active thermal component's second power allocation is greater than or equal to an active thermal component's maximum operating power;
responsive to determining that the active thermal component's second power allocation is greater than or equal to the active thermal component's maximum operating power, allocating, by the TMM, the active thermal component's maximum operating power as the active thermal component's second power allocation; and
responsive to determining that the active thermal component's second power allocation is less than the active thermal component's maximum operating power or responsive to allocating, by the TMM, the active thermal component's maximum operating power as the active thermal component's second power allocation, updating, by the TMM, the power remaining after the second power allocations to be equal to the power remaining after second power allocations minus a difference of the active thermal component's second power allocation and the active thermal component's first power allocation.

12. The method of claim 1, wherein allocating, by the TMM, the third power allocation to each active thermal component further comprises:
determining, by the TMM, whether the active thermal component's second power allocation is greater than zero;
responsive to the determining that the active thermal component's second power allocation is zero:
setting, by the TMM, the active thermal component's maximum power equal to zero; and
updating, by the TMM, a total maximum power of all active thermal components to a sum of the total maximum power of all active thermal components considered previously and the active thermal component's maximum power; and
responsive to determining that the active thermal component's second power allocation is greater than zero:
setting, by the TMM, the active thermal component's maximum power equal to the active thermal component's maximum power; and
updating, by the TMM, the total maximum power of all active thermal components to a sum of the total maximum power of all active thermal components considered previously and the active thermal component's maximum power.

13. The method of claim 12, further comprising:
calculating, by the TMM, how much power could be allocated until all active thermal components are maxed by adding the total maximum power of all active thermal components to a difference of the power available and a power remaining after all third power allocations.

14. The method of claim 13, further comprising:
responsive to determining that the power that could be allocated until all active thermal components are maxed is less than or equal to a second predetermined power value, setting, by the TMM, an excess power ratio to one to prevent division by zero or a negative number; and
responsive to determining that the power that could be allocated until all active thermal components are maxed is greater than the second predetermined power value, setting, by the TMM, the excess power ratio to a first value determined by dividing the power remaining after all third power allocations by the power that could be allocated until all active thermal components are maxed.

15. The method of claim 14, further comprising:
responsive to setting the excess power ratio to one to prevent division by zero or a negative number or setting the excess power ratio to the first value determined by dividing the power remaining after all third power allocations by the power that could be allocated until all active thermal components are maxed, setting, by the TMM, a total allocated power to zero.

16. The method of claim 15, further comprising:
responsive to determining that the active thermal component's second power allocation fails to be greater than zero, setting, by the TMM, the active thermal component's third power allocation to zero.

17. The method of claim 15, further comprising:
responsive to determining that the active thermal component's second power allocation is greater than zero, adding, by the TMM, excess power, such that the active thermal component's third power allocation is equal to a sum of the excess power ratio times a difference of the active thermal component's maximum power and the active thermal component's second power allocation and the active thermal component's second power allocation.

18. The method of claim 17, further comprising:
responsive to determining that the active thermal component's third power allocation is greater than or equal to the active thermal component's maximum power, setting, by the TMM, the active thermal component's third power allocation equal to the active thermal component's maximum power.

19. A method for controlling an active thermal component of a vehicle, the method comprising:
calculating, by a thermal management module (TMM), an active thermal component power setpoint based on a power budget and a component prioritization;
calculating, by the TMM, a first error value based on a difference between the active thermal component power setpoint and an active thermal component instantaneous power consumption;
calculating, by the TMM, an active thermal component actuation limit using the first error value;
calculating, by the TMM, a second error value based on a difference between a primary setpoint and a primary feedback;
calculating, by the TMM, a system output variable using the second error value; and
limiting, by the TMM, the system output variable based on the active thermal component actuation limit or the active thermal component power setpoint.

20. The method of claim 19, further comprising:
commanding, by the TMM, a component speed or a component power of the active thermal component based on the limited system output variable.
